(19) United States
(12) Patent Application Publication
(10) Pub. No.: US 2014/0089118 A1
(43) Pub. Date: Mar. 27, 2014

(54) "Pay/load" product sale at national retailers

(71) Applicants: Randy J. Templeton, Sugarland, TX (US); Jose A. Vertiz, Missouri City, TX (US)

(72) Inventors: Randy J. Templeton, Sugarland, TX (US); Jose A. Vertiz, Missouri City, TX (US)

(21) Appl. No.: 13/987,476

(22) Filed: Jul. 30, 2013

Related U.S. Application Data
(60) Provisional application No. 61/741,993, filed on Aug. 1, 2012.
(60) Provisional application No. 61/855,556, filed on May 20, 2013.

(51) Int. Cl. G06Q 20/12; G06Q 20/20

(52) U.S. Cl. CPC G06Q 20/12; G06Q 20/202
USPC 705/21; 705/40

(57) ABSTRACT

Method and apparatus for effecting a bill-pay/account-loading program as a “product” for sale at retailers, preferably including consumer involvement 1) in establishing a relationship with a payment facilitator and with receiving a relevant “app;” 2) in securing a barcode or other product identifier to use at a retailer to purchase a bill-pay/account loading “product,” which could be a gift card controlled by the payment facilitator; and 3) in confirming the tendering of cash or the like to a retailer, preferably based on a retailer receipt and consumer device information; alternately including consumer funding of a retailer gift card and a payment provider paying a consumer's bill using the funded gift card and settling with the retailer based on the amount in the gift card account, preferably after the provider verifying funding of the card account by accessing gift card records.

This invention relates to and claims priority to co-pending provisional application No. 61/741,993, filed Aug. 1, 2012, entitled Pay/Load Product for Sale at National Retailers, inventors Randy J. Templeton and Jose A. Vertiz; and to co-pending provisional application Ser. No. 61/855,556, filed May 20, 2013 entitled “Pay/Load Product for Sale at National Retailers,” inventors Randy J. Templeton and Jose A. Vertiz. The above two provisional applications are herein and hereby incorporated by reference in their entirety.

### FIELD OF THE INVENTION

The invention lies in the field of bill-pay/account-loading services, and in particular in the field of bill-pay/account-loading services for consumers paying bills with cash and occasionally requiring immediate bill payment or account-loading. (“Bill-pay” may be used at times hereinafter, for simplicity, to also cover “account-loading.” Such use as a shorthand should be understood, as paying a bill is frequently regarded as funding an account. A “bill-pay” facilitator is also interchangeably referred to as a payment facilitator or payment provider.)

### BACKGROUND OF THE INVENTION

A problem to be solved for cash-based consumers in the “bill-pay” industry is to provide consumers with a convenient and cost effective location for transacting the payment of bills or loading of accounts and for also providing, at times, immediate payment of bills. The “bills” could be utility bills, mortgage bills, credit card bills, etc. “Accounts” to be “loaded” could involve prepaid card accounts, iTune accounts, phone accounts, etc. “Convenient” locations for a bill-pay transactions, in particular for a cash transaction, include retail outlets such as common national retailers, convenience stores, grocery stores, drug stores, and electronic/appliance stores, many open 24/7. “Immediate” should be understood herein to mean at least on the same day, preferably within hours, possibly within minutes.

One issue preferably to be solved in regard to providing immediate bill-pay/account-loading services for cash-based consumers at convenient locations is avoiding a necessity for pre-establishing a real-time closed-loop communication channel between the retail location and a bill-pay facilitator without sacrificing certain benefits of a closed-loop communication. One benefit of closed-loop communication is the possibility of essentially real-time reliable verification that the cash to fund the payment was indeed received from the consumer at the merchant. Upon that verification a subsequent bill-pay transaction on behalf of the consumer can be soundly founded.

Closed-loop direct communication between a merchant receiving a consumer's cash payment and a payment facilitator significantly reduces the risk of consumer fraud for the facilitator that is paying consumer bills “immediately,” such as within hours or minutes or at least on the same day. A payment facilitator can substantially rely on closed-loop essentially real-time communication channels with established retailer locations with whom the facilitator has established a contractual as well as a direct communication relationship.

However, establishing an essentially real-time closed-loop communication channel between each retail location and a payment facilitator involves technological and logistic undertakings that have become regarded by many retailers as burdensome. While the benefit to the retailer from the bill-pay/account-loading service is that the service draws consumers into the store, not to mention that the retailer receives a profit from the transactions, the technological and logistic burden of establishing closed-loop essentially real-time communication is frequently deemed to outweigh the benefits. (A closed-loop bill-pay system has been utilized, for instance, with the Green Dot Money Pack card.)

As one alternative, Visa and the like provide what is referred to as an “open system” prepaid reloadable variable amount card. The Visa card leverages off of the so-called “open-loop system” established between the retailer and the card associations and their banks, permitting verified card purchasing transactions where the card is immediately useable. The down-side of using the Visa system for immediate bill-pay is that “interchange fees” are usually required to be paid by the purchaser for using the “open-loop system as well as fees to purchase the card. As a consequence, the consumer must anticipate the fees that will be involved when purchasing a Visa prepaid card or the like to immediately pay a bill and must load a sufficient amount on the card. The typical result is that loading a Visa or the like prepaid card to pay bills results in higher overall costs for the consumer as well as frequently leaving undesired residual amounts on the card. Furthermore, use of the above open system prepaid card requires the consumer to access the third party payees, or bitters, directly, such as by Internet, and to personally direct the payments onto the consumer's account with the payee using the card. Alternately, the consumer can access a payment facilitator to pay the consumer's hills using the open system card, but with this option the total fees charged to the consumer will go up even further. The total fees will include not only the fees for the card and the interchange fees, above, but also fees for the payment facilitator.

Moreover of the above bill-pay systems, the open system prepaid card system and the closed-loop prepaid card system, usually require a consumer to locate a card in a retail store, purchase the card and carry the card about, entailing a risk of loss associated with a bearer-type instrument.

The instant invention aims to provide a solution to the above problems without losing their benefits. In comparison to a closed-loop system requiring real-time direct closed-loop communication between a bill-pay facilitator and a retailer, the instant invention shifts the burden of establishing private individual direct communication with the bill-pay facilitator to the consumer. The consumer is the one who benefits directly from the system. Preferably, after an initial contact by a consumer with a payment facilitator, subsequent communication is carried out through an “app” supplied to the consumer's mobile phone or mobile device by the payment facilitator. Alternately, direct communication through the web is possible. As far as the retailer is concerned, providing the bill-pay/account-loading service with the instant invention functions much in the same way as providing any other retail “product,” or in an alternate embodiment, could function like selling and then debiting a “gift card.”

In comparison to the “open-loop” system, especially as combined with a payment facilitator, the instant invention offers substantial cost effectiveness and efficiency for the consumer. The fee paid to purchase and/or load a prepaid card, as well as fees paid by the consumer to use an open system prepaid card, can be replaced by a significantly lower fee charged by the instant payment facilitator.

### SUMMARY OF THE INVENTION

In a preferred embodiment the invention includes methods and apparatus for offering a bill-pay/account-loading program as a “product” for sale at national retailers, preferably associated with a UPC and/or possibly a retailer gift card account. Preferably the method includes a payment facilitator: receiving from a consumer information regarding a consumer account at a biller or the like and an amount to be paid into or loaded onto that account at the biller or the like; supplying to the consumer a POS-communicable indicator related to the amount, preferably related to a UPC or the like and/or a gift card number; receiving by the payment facilitator preferably from an “app” supplied to the consumer, information regarding a payment made to a retailer, and preferably information regarding a related retailer receipt, indicating a payment to the retailer of an amount appropriate to the indicator and UPC code and/or gift card funded; and paying the amount into the identified consumer account at the biller or the like, preferably upon sonic further verification of the retailer receipt information and/or other received consumer information regarding the consumer payment to the retailer.

Preferably the above method includes receiving, from an “app” supplied to a consumer, mobile device information helping to confirm the consumer's transaction at the retailer; e,g, a “purchase” for cash at the retailer of a pay/load “product” (and/or of a gift card account.) This confirming mobile device information could be gps information and/or camera information and/or gyroscopic information.

More preferably a preferred embodiment for remitting payments on consumer accounts comprises receiving, by a payment facilitator, from an application supplied to a consumer device, information regarding a consumer cash payment at a retailer, the payment associated with a UPC supplied by the payment facilitator to the consumer and to the retailer or to a gift card account number. The method preferably includes remitting an amount by the payment facilitator to a consumer account at a biller, the remitted amount being related to the payment amount. Preferably this method includes, by the payment facilitator, supplying to the app furnished to the consumer device at least one POS communicable indicator of a UPC and/or retailer gift card number and may include supplying to the retailer a plurality of UPC's, associated with the payment facilitator, the plurality of UPCs having various price points.

Another preferred embodiment of the instant invention may include consumer device software for facilitating bill payments or loading of accounts, the consumer device software structured to communicate with a payment facilitator information regarding the consumer device and information regarding a receipt, the receipt generated by or at a retailer POS, the receipt recording or reflecting a payment to the retailer, the receipt related to a UPC that indicates a bill-pay account loading product or a gift card. Preferably the consumer device software is structured to communicate to the payment facilitator an account ID and an amount ID and, further preferably, a store ID. Preferably the consumer device software is structured to receive an indicator of a UPC and/or gift card account from the payment facilitator and to display the indicator of a UPC and/or gift card account to a retailer at a retailer POS, preferably for automated reading. Preferably further the consumer device software is structured to communicate information regarding the consumer device itself to the payment facilitator, such as GPS information and/or gyroscopic information and/or camera information and/or audio information that relates to and helps verify the historic consumer payment transaction at the retailer.

### BRIEF DESCRIPTION OF THE DRAWINGS

A better understanding of the present invention can be obtained when the following detailed description of the preferred embodiments are considered in conjunction with the following drawings, in which:

FIGS. 1A-1C present transactional flow, possible payment facilitator risk management steps and a sample mobile device with apps, respectively.

FIGS. 2A and 2B represent steps and stages associated with two preferred embodiments.

FIGS. 3A and 3B likewise describe steps in two preferred embodiments of the invention.

The drawings are primarily illustrative. It would be understood that structure may have been simplified and details omitted in order to convey certain aspects of the invention. Scale may be sacrificed to clarity.

### DETAILED DESCRIPTION OF THE PREFERRED EMBODIMENTS

### Discussion of Instant Invention in General

Associated with a first preferred embodiment of the instant novel “pay/load” product is a uniform product code (UPC), possibly a set of UPCs, each associated with a price point, or possibly one or more “variable amount” UPCs. Either the variable amount UPC or each of a set of pay/load UPCs with its price point can be represented by a communicable indicator, preferably a point of sale (POS) automatically readable presentable indicator, such as a a barcode. The retailer already has automated hardware, software and protocols for dealing with “products” represented by indicators of UPCs, especially automatically readable or scannable indicators (presentable indicators,) such as barcode or NFC technology (discussed more fully below.) The price point (cash amount to be paid) for each “pay/ load” product indicated by either a variable amount UPC or one of a set of UPCs would be established, as is known in the retail industry, by the facilitator with the retailer. (The facilitator plays the role of the “product” manufacturer or supplier vis-à-vis the retailer.) Each UPC can be interpreted from the indicator by the retailer's POS equipment and displayed by the retailer. Settlement with the facilitator-supplier (e.g. “product” manufacturer) can be similar also to settlement for the sale of any other product from a supplier sold by a retailer, especially consignment products. Thus, sale of a “pay/load” product requires essentially no extra hardware or software for the retailer.

Note that a “variable amount” UPC could be adopted (UPC 128) in lieu of a set of UPCs with different price points. A variable amount UPC could enjoy a range $20-500, that is read at the POS instead of the POS system returning a predetermined fixed amount or price point for the item. The advantages of using a variable amount UPC, especially in the gift card space (discussed subsequently below,) is that the retailer does not have to allocate memory space for multiple UPCs to display multiple cards at fixed amounts, e.g. 25, 50 or 100, manage the inventory of multiple fixed denomination cards and run the risk of being out of specific denominations cards that a consumer wants to purchase. Further, a consumer has greater flexibility in the value of the card account they want to purchase.

A “product” price thus can be supplied, one way or the other, to a POS upon entering or scanning an indicator, such a barcode, presented by a consumer at the POS much as with any other retailer product.

The preferred method of “presenting” an indicator at a POS is a via the scanning of a consumer's mobile electronic device, said indicator having been acquired by the mobile device from a payment facilitator. It should be mentioned that various ways of automated communication between a device like a smart phone and a device like a POS scanner or the like are contemplated and are within the ambit of the invention. For instance, the smart phone could utilize NFC technology. NFC is short for Near Field Communication, is a short range wireless RFID technology that makes use of interacting electromagnetic radio fields instead of the typical direct radio transmissions used by technologies such as Bluetooth. NFC is meant for applications where a physical touch, or close to it, is required in order to maintain security. NFC is planned for use in mobile phones for, among other things, payment, in conjunction with an electronic wallet, and for setting up connections between Bluetooth devices (rendering the current manual Bluetooth pairing process obsolete). The technology is promoted by the NFC-Forum. Specifically NFC is a set of short-range wireless technologies, typically requiring a distance of 10 cm or less. NFC operates at 13.56 MHz on ISO/IEC 18000-3 air interface and at rates ranging from 106 kbit/s to 424 kbit/s. NFC always involves an initiator and a target; the initiator actively generates an RF field that can power a passive target. The passive target could be on the consumer's device or smart phone. This enables NFC targets to employ very simple forms such as tags, stickers, key fobs, or cards that do not require batteries. NFC peer-to-peer communication is possible, provided both devices are powered. A patent licensing program for NFC is currently under development by Via Licensing Corporation, an independent subsidiary of Dolby Laboratories. A public, platform-independent NFC library is released under the free GNU Lesser General Public License by the name libnfc.

To perform a bill-pay, the consumer has preferably received the appropriate indicator (barcode or the like) through a communication with his/her payment facilitator, preferably using a software application (“app”) supplied to a mobile device of the consumer, such as a smart phone, but possibly by communicating over the web or by other means. Preferably the consumer can simply display the barcode or indicator on the mobile device to a scanner or the like reader at a POS.

The payment facilitator in turn has supplied the retailers, as is known and customary in the retail business, with one or more variable amount UPCs or a set of UPCs (uniform product codes) or the like each associated with (or associatable with a price point, representing a payment facilitator “product.” Each UPC of a set could be understood to be associated with a certain bill-pay “product” of the facilitator. The payment facilitator might, for instance, supply 1,000 to 4,000 UPCs, each having price points differing by, say, 25 cents.

The consumer accepts the responsibility of securing a suitable indicator of a UPC for the retailer from the payment facilitator for the needed bill-pay amount, preferably using the consumer's mobile device like a smart phone, likely through an “app” supplied to the consumer by his/her payment facilitator. Again, the indicator is likely a barcode.

The consumer has likely already identified (or will identify) to the payment facilitator the intended: third party payee(s), the amount(s) to be paid on the consumer's behalf, and the consumer's account number(s) at the payee(s) for the receipt of the amount(s). The consumer preferably has already agreed upon a fee, or will agree upon a fee, with the payment facilitator for performing the bill-pay function, thereby helping to determine a specific or nearly specific UPC “product” to purchase. (The payment facilitator likely permits the retailer to retain a portion of the fees charged, upon settlement.)

The retailer, after scanning or entering the UPC as presented by the consumer, and in return for the proper cash payment, issues to the consumer a retailer receipt, based on the price point specified by the indicator or barcode of the UPC and the cash tendered by the consumer.

The consumer preferably next communicates information from and/or about the receipt back to the payment facilitator, preferably aided by the consumer mobile device “app.” Such communication of information could include taking and forwarding a picture of the receipt and/or inputting receipt info and/or by other information forwarded by the “app,” including mobile device GPS history and/or gyroscopic history. Such can help to verify the payment of the cash to the retailer associated with the UPC. In addition, if the consumer has not already done so, the consumer will specify the payee or payees, the amount or the amounts to be paid to each payee, and the account numbers at the payees.

Alternately, if a retailer provides a gift card program, a payment facilitator can make arrangements with the retailer for the consumer's cash payment to fund a gift card, meaning that the funds tendered would be associated with a gift card number in the retailer records. These records are typically kept by the retailer or the retailer's agent in this regard. Preferably the facilitator lines up a set of specific gift card numbers for its use, or at least one number. A card number can be coded into a presentable indicator, or a portion of a presentable indicator, as well as or in lieu of a gift card UPC, if desired. The gift card may or may not be associated with a UPC. Thus when the consumer names an intended retailer at which the consumer intends to make a cash payment, and the retailer subscribes to a gift card program that has a relationship with the payment facilitator, the payment facilitator can provide, likely from a pre-established stock of numbers, an indicator of a gift card number to the consumer, addition to or in lieu of a UPC number. Such becomes an indicator of an account, the account being a gift card account that will be de facto controlled by the payment facilitator. In such manner fortuitous use is made of an existing gift card accounting system that is likely accessible in real-time by the facilitator. The gift card number as supplied to the consumer can have encoded by the facilitator the precise amount the consumer needs to pay in order to cover the bill payment service plus any fee charged. When the consumer presents the gift card number to the retailer, such as by a barcode scanned at a POS by the retailer, the exact price that the consumer needs to pay to take care of the bill-pay transaction in question can be displayed, by the retailer and collected by the retailer. The retailer will indicate to its gift card accounting system that this particular gift card number has been loaded with a certain amount, e.g. the cash amount collected or a function thereof. In settlement between the facilitator and the retailer, either the gift card amount (less retailer fees) can be remitted to the payment facilitator and the card account debited (likely zeroed out) or, for an alternate accounting system, the amount less retailer fees can be applied to purchase a payment facilitator UPC “product,” for which the retailer can then be invoiced by the payment facilitator, as above.

A key benefit of the use of a gift card number is that a payment facilitator may be able to access in substantially real time the accounting system for the gift cards, either with the retailer at a local or centralized location or with the retailer's transaction provider. The payment provider can then ascertain with a high degree of reliability that the account associated with the gift card number indeed has been supplied with the requisite funds based on the tender of cash by the consumer. Such verification reduces the facilitator's risks.

In either embodiment above, the payment facilitator, preferably after any verification step, makes a timely payment of the indicated amount to the identified account at the third party payee, as requested by the consumer, and transmits a confirmation of the payment to the consumer. The retailer has collected the cash from the consumer, as indicated from the indicator or barcode. The retailer remits to the facilitator, upon periodic settlement agreed upon proportions of cash collected relating to the relevant indicators, as is standard retailer practice in regard to “products” supplied, for instance on consignment by suppliers.

To summarize particularly preferred embodiments, consumers first enroll with a payment facilitator, preferably providing personal data and communication device information. The payment facilitator provides a software application (app) to be downloaded onto a consumer mobile communication device, such as a smart phone. When an enrolled consumer wishes to make a payment to, or load art account at, a third party payee, the consumer contacts the payment facilitator through the “application.” The consumer indicates that a payment has been, is, or will be requested to be made by the facilitator to a specific account at a third party payee, of a specific amount, based upon a payment of cash to a specific retailer. The payment facilitator, assuming the information is in order, provides the consumer with an indicator, such as a barcode, to be used at the retailer. The consumer agrees with the payment facilitator upon a fee for the transaction. The indicator, such as of a UPC and/or a gift card number or both, will indicate to the POS the product and the cash to be paid, and possibly other information. The consumer presents the indicator such as by display on a mobile phone to a retailer POS such as a scanner, together with the appropriate cash, and receives a retailer receipt. Subsequent to the transaction, the consumer communicates information regarding the transaction and retailer receipt, as by a photo and other information, to the payment facilitator. The app may supply other information to the facilitator, such as GPS information, gyroscopic information and time information. The payment facilitator verifies retailer receipt information and other information against fraud and, if a gift card account is indicated, checks with the gift card transaction processor if possible for funds in the relevant gift card account. Upon passage of an appropriate time, the payment facilitator makes the agreed upon payment to the specified account(s) of the specified amount(s), and confirms the payment(s) to the consumer. Preferably, periodically, the retailer remits in settlement to the payment facilitator agreed upon proportions of the cash collected in regard to the presentations of the indicators for the “payment products” or gift card purchases. Preferably, a retailer updates a payment facilitator with a summary of is relevant transactions several times a day. Such also helps guard against consumer fraud.

To further provide protection against consumer fraud, a payment facilitator might request a consumer to photo and/or to otherwise communicate a copy of the third party bill to be paid. Such provides the payment facilitator with the possibility of determining the due date and of delaying payment on the account until close to the due date. Delaying payment may provide the facilitator the possibility of cross-checking retailer receipt information received from the consumer, such as with a periodic report from the retailer mentioned above reporting on UPC or gift card sales relating to the facilitator. (Manufacturers are requesting or requiring barcode reports with greater regularity today, sometimes hourly, in order to determine the effects of marketing programs, promotional programs and/or for inventory control.) A payment facilitator may likely also attempt to verify a receipt prior to payment by performing a traditional fraud risk analysis based on consumer history data and transaction data history, as well as by using communication device history data as collected, relating to the transaction. Importantly, a payment facilitator may seek confirmation data from a mobile phone that the phone presented the barcode to the retailer. That confirmation data from the mobile phone might take the form of any or all of GPS history; gyroscope history; camera history; microphone history; scan history; or any other mobile communication device history that might confirm that the indicator or barcode was indeed presented to a POS scanner of the retailer in question at the relevant time. Gyroscope history might relate to whether the consumer mobile device was oriented in the proper direction for a barcode to be read at the proper time at the proper UPS location. The app might require the mobile device camera and/or microphone to be on in order to present the indicator or bar code, and an automated scanning device might record a visible and/or audio “fingerprint.” Also, the payment facilitator might may communicate to a consumer not only a barcode representing the proper price point but also a “coupon.” The coupon could be presented with the indicator to the retailer. There might be one indicator for the product payment amount and one indicator, also a barcode, for the coupon. Thus, coupon related information could be further indicated on the receipt. A picture of such receipt with “coupon” information could further act as a protection against an attempt to fraudulently fabricate a receipt. If the cash transaction from the consumer to the retailer were accounted for by the retailer as a purchase of a gift card then the payment facilitator may be able to enter in substantially real-time into the database of the gift card system to determine if a gift card with the proper number was funded with the proper amount.

In general, the instant bill-pay/account-loading service involves four basic entities. One entity is called the consumer, who is the bill-payor or account-loader, generally the recipient of the benefit of the bill being paid or account being loaded. This consumer (also referred to as a customer of a retailer) prefers to “pay” with cash and frequently requires fast service. The second entity is the payment facilitator, who preferably supplies a computer application to the consumer or to a consumer device, preferably to a mobile communication device such as a smart phone. The payment facilitator functions as the supplier of a bill-pay “product” or as the supplier of a gift card account number, to be “sold” at the retailer to the consumer, the “product” and/or gift card account likely being represented by UPCs or the like. The third entity is the retailer, in particular common national retailers having POS devices, preferably with automated equipment functioning in standard manners in regard to selling “products.” The fourth entity, inherently involved, is the third-party biller or payee, the one who is maintaining an account for the consumer, the account that is getting paid or loaded.

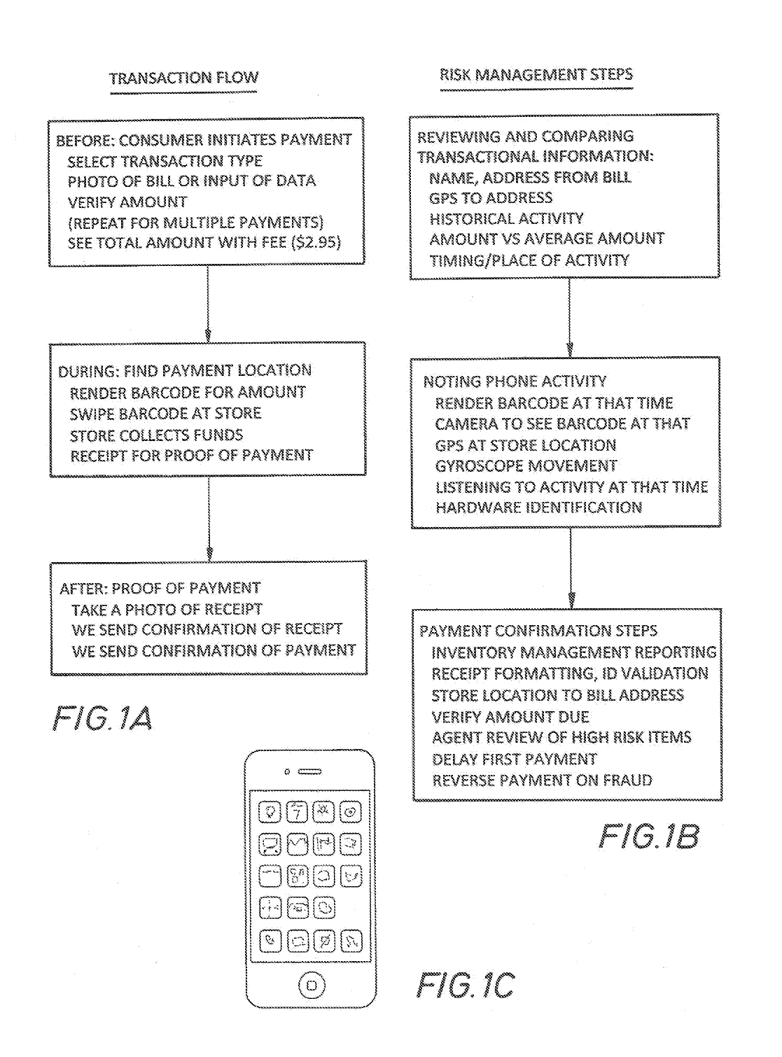

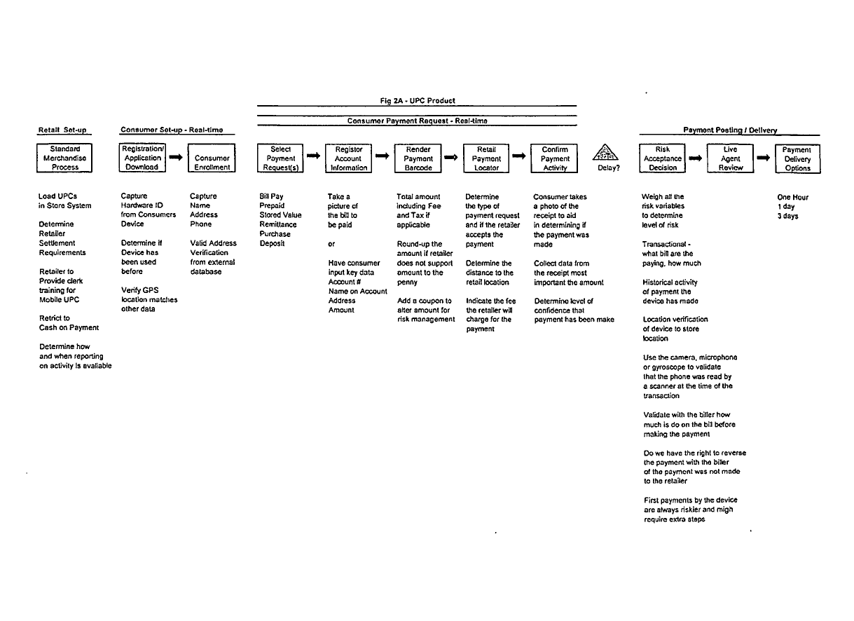

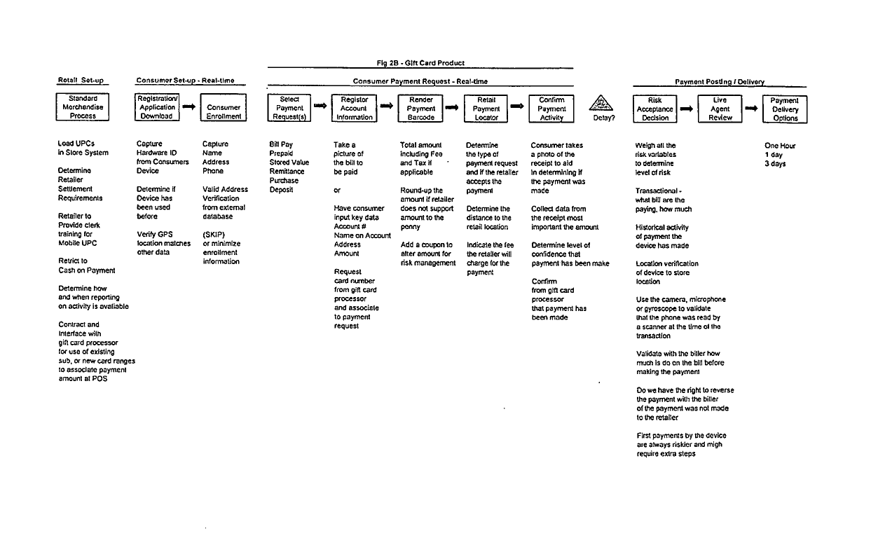

Five “items” are generally involved. One “item” is a consumer account at a biller or payee, to be loaded or paid, possibly in regard to a bill. The second “item” is cash to be handed to a retailer by a consumer, to pay for the “product” (“product” covers “service” herein) of having the consumer's account above loaded or paid. “Item” three is a barcode or like presentable indicator, readable or enterable or determinable at a retailer point of sale, preferably automatically, and preferably indicating a UPC and/or a gift card account. See FIG. 4 pages 1-5 of the two provisionals incorporated by reference herein for background information in regard to barcodes. Preferably the indicator would be scannable or automatically readable. The indicator or barcode preferably directly or indirectly indicates to the retailer the price of the “product” or value of the gift card being sold. Item four is a retailer receipt. See FIG. 5 pages 1-12 of the two provisional applications incorporated by reference herein for illustrations of typical retailer receipts. This retailer receipt is issued by a retailer to a consumer reflecting that the consumer paid in return for the products identified. The fifth “item” is a consumer communication device, preferably a mobile device, preferably a smart phone. See FIG. 1C. (Arguably the functionality of the device could be constituted by a plurality of devices.) The consumer communication device, preferably under the control of a payment facilitator supplied app, should preferably be able to communicate a biller account ID, a related amount ID, and preferably a retailer ID to the payment facilitator. The consumer communication device should also preferably be able to receive and display, and/or to reproduce, to a retailer POS reader, a readable indicator or barcode, which indicates directly or indirectly the product or gift card, including a price and preferably the supplier (e.g. the payment facilitator.) The communication device should also preferably be able to subsequently communicate retailer receipt information to the payment facilitator, such as by taking a picture and transmitting the picture of a physical receipt and/or such as by transmitting receipt information as well as other verifying information.

### Summary of Benefits of the Preferred Embodiments

Benefits of the preferred embodiments include the feature that the bill-pay provider can better control and lower the costs of the bill-pay process for a consumer, primarily by avoiding using open system networks with their fees, including associated risk fees and banking fees, and at the same time without having to establish closed loop communications with each retailer.

A further benefit of the preferred embodiments is that it is easier for the consumer to electronically acquire an indicator of a UPC product or a gift card account or the like, through a mobile app supplied from a bill-pay provider than, for instance, having to search through a retail store for a rack of plastic indicating prepaid cards and/or remembering to carry such a “bearer” card around without losing it.

A further benefit of the preferred embodiments is that the loading can be precise or closely precise for the consumer, without leaving significant residual amounts remaining in prepaid accounts. The provider, knowing the amount to be paid, can compute all of the fees upfront and state to the consumer and retailer the precise price of the transaction.

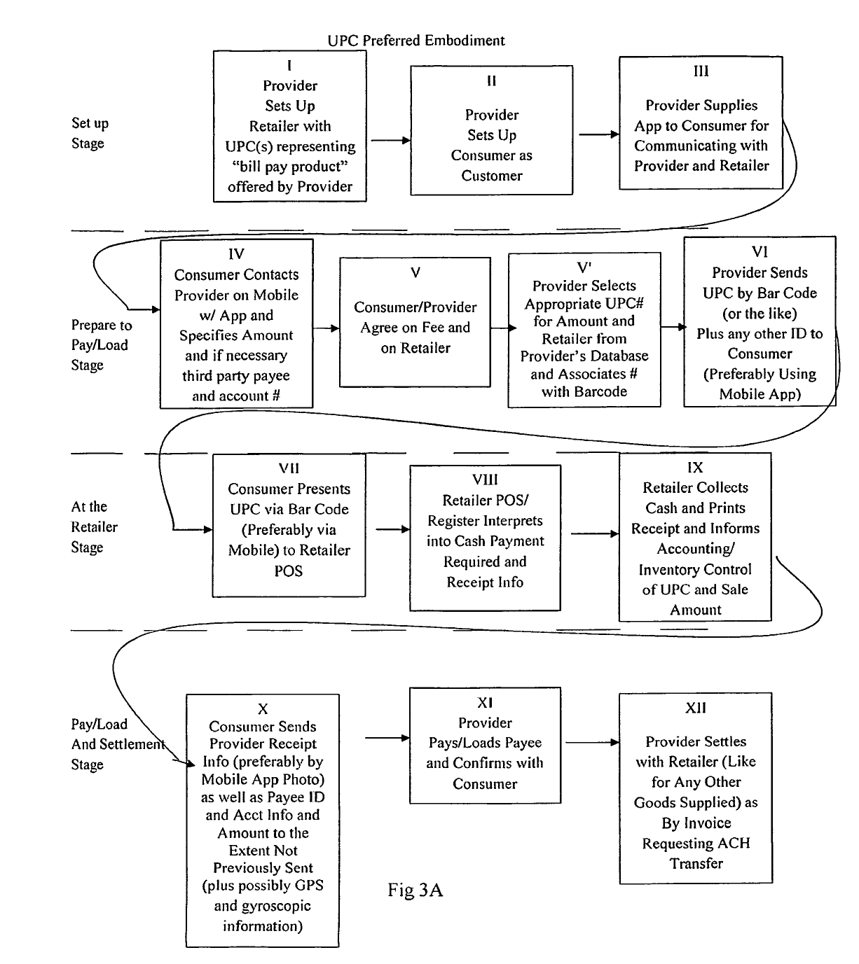

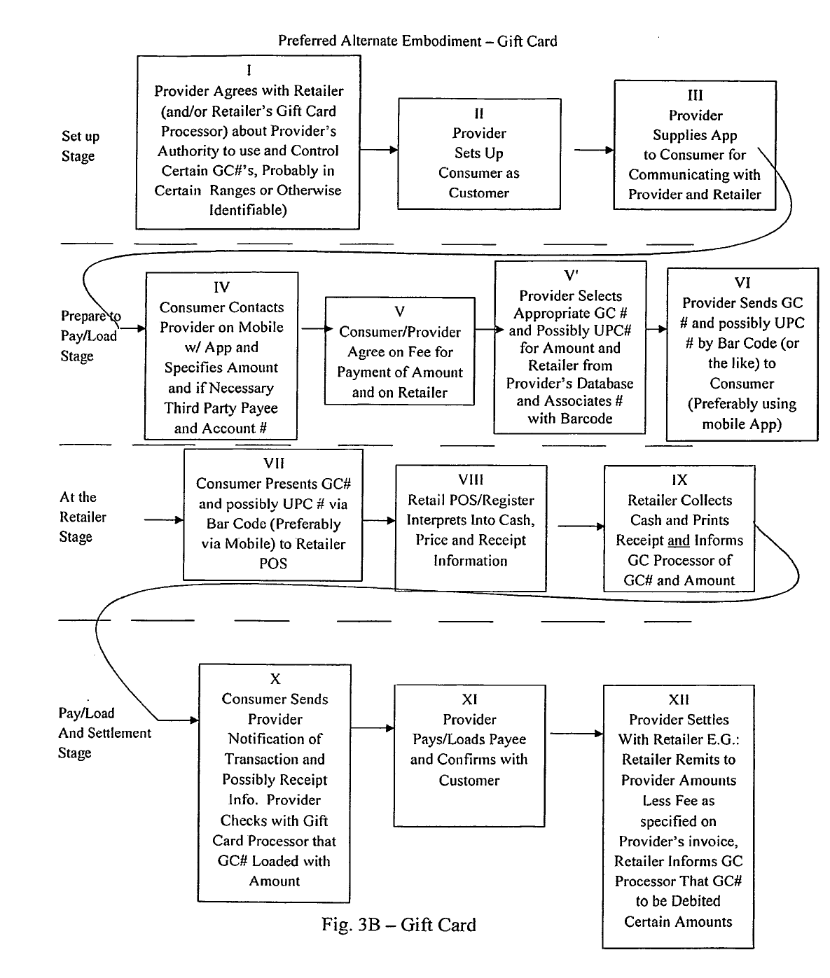

A further benefit of the alternate embodiment of FIG. 3B is the possible ability of the bill-pay provider to directly verify funds in a gill card account prior to paying a bill for a consumer. This verifying can be either through or with the retailer, or through or with a retailer's transaction processor, both possibly substantially in real time.

### Understanding of Terms

“Product” is used to cover either goods or services or both.

“Bill-pay should be understood to include generally paying a bill or loading an account for a consumer. “Immediate bill-pay” should be understood as paying or loading within 24 hours of notification of a consumer payment to a retailer associated with a provider supplied indicator and identification of payee, consumer account and amount to be paid to the payment provider.

A “paid” bill means a bill is no longer regarded as outstanding; “pays” means makes paid.

A “bill-pay provider” or payment facilitator pays third party billers as authorized by consumers. A “third party biller,” is unrelated to the retailer and the bill-pay provider. The term is used to refer to a creditor of a consumer but also covers herein a third party who generally maintains an account for a consumer, which account can be loaded.

“Bill-pay information” includes identification of a consumer account and of an amount with a third party biller, the amount being at least related to if not identical with that which the payment facilitator is to tender on behalf of a consumer.

A “presentable indicator” comprises information that can be entered pictorially and/or digitally or otherwise at a retailer POS, sometimes referred to as a POS-communicable indicator.

Two preferred embodiments are illustrated in FIGS. 1A, 2A and 2B and 3A and 3B, which show various preferred steps and stages of the invention.

To summarize, FIGS. 2A and 3A form one preferred embodiment wherein payment facilitator (PF) establishes one or a set of UPCs, having different price points, with a retailer (R). Together with the set of UPCs, the payment facilitator (PF) preferably arranges provision for reporting of sales by R to PF as soon as, and as frequently as, possible, and for the invoicing and payment of the facilitator's share of the collected amounts by R to PF, reflecting UPC products sold by the retailer, as soon as possible. Also PF may provide for periodically supplying sets of coupons, likely also indicated by UPCs, the coupons being associated with information useful for verification of the transaction, preferably that will cause a print on a receipt upon the presentation of the coupon with the payment.

The PF preferably enrolls consumers in the payment program and provides an app to consumer (C) devices (app). The consumer app subsequently contacts PF, preferably with a biller account ID, an amount ID and a retailer store ID. C agrees on a fee with PF.

PF supplies the consumer app with an indicator of a UPC having an appropriate price point, preferably in the form of a bar code or similar indicator, easily scannable by a retailer at a POS. Possibly PF also supplies the consumer app with a coupon, also preferably a bar coded UPC, with associated receipt printable information, as mentioned above.

The app preferably presents the one or more indicators (such as of a UPC for a “payment product” and/or possibly a UPC for a “coupon”) to R. R receives from C an amount corresponding to the price point for the UPC product as indicated by the UPC presented. R provides C with a receipt of the transaction indicating at least the “product” and price paid and possibly some PF supplied coupon information.

The consumer or the app preferably contacts PF, and supplies to PF receipt information as well as preferably other app device information. Upon suitable verification of the supplied information, PF timely pays the biller (or account holder) the agreed amount (taking into account an agreed upon fee) to be placed into the consumer account ID therein maintained. Preferably, if possible, PF waits until R verifies the payment of the price by C to R before paying into the consumer account.

Preferably R periodically reports C-received amounts to PF in regard to PF's UPC “products” sold. R remits the proper share of C-received amounts to PF, preferably upon invoicing of R by PF.

A payment facilitator may arrange for a consumer to acquire an appropriate UPC on a scan sensitive background as well as associated in some fashion with a coupon. Subsequent to a presentation to a retailer, and having the UPC code read and having paid the price, the consumer can preferably supply to the payment facilitator a copy not only of the receipt, that may have coupon indicative information thereon, but also a copy of the indicator with the scan sensitive background material.

The preferred embodiment of FIG. 3A is mirrored by diagram 2A and is now reviewed in detail as a series of 13 steps. The ordering or timing of the steps do not necessarily need to follow that illustrated in FIG. 3A. There is some inherent ordering of the steps, however, given the logic of the invention.

The preferred embodiment of FIGS. 2A and 3A, divided herein into 13 steps, is also divided into four stages. The first stage is referred to as the setup stage.

Box I is the first step of the setup stage where a pay/load “product” provider sets a retailer up to sell the provider's pay/load “product.” The provider will preferably provide the retailer with one or a set of UPC codes or the like product identifiers. (Although arguably pay/load is a service, it is referred to generically herein as a “product.”) The UPC codes might comprise, for instance, 500 different codes, each one for a different price point at dollar intervals, say from $50 to $500. Each UPC code can be interpreted by the equipment of the retailer, as is customary for the retailer, to require the payment by the consumer of a particular price. Thus, the pay/load “product” is sold like any other product sold by the retailer. Arguably the pay/load “product” can be viewed as supplied to the retailer on a consignment basis. That is, the retailer has not pre-purchased the “product.” Rather, the retailer pays for the product, e.g. pays the provider's invoice or the like, only after a consumer has purchased the product at the retailer.

Box II refers to a step of setting up a consumer to be in a position to purchase a pay/load product. Preferably consumers are pre-enrolled with the provider. Preferably the consumers supply certain information about themselves and/or their mobile devices. The setup stage and the upfront providing of information helps to protect the provider against consumer fraud.

Box III in the setup stage indicates that the provider preferably supplies a software application, or app, to the consumer for use in a particular consumer mobile device, such as a smart phone. Use of the provider app further helps protect the provider against consumer fraud.

Moving to the prepare to pay/load stage, Boxes IV and V refer to a point in time where the consumer contacts the provider, preferably through the supplied “app,” and preferably now requests that an identified consumer account at an identified third party payee or biller be paid an identified amount, possibly by an identified time. Preferably the consumer communication also identifies the retailer where the consumer proposes to “purchase” this pay/load “product.” The consumer and the provider agree on a fee that the consumer will pay in order for the provider to supply the pay/load product on a timely basis. In Boxes IV or V the consumer might also supply the provider with a copy, such as by a picture taken with a smart phone, of the actual bill that the consumer wishes the provider to pay. Such again further helps protect the provider against consumer fraud and may give the provider an indication of any time deadline.

In Boxes V and VI the provider selects an appropriate UPC number for the amount and for the retailer selected by the consumer. The provider probably maintains a database in this regard. The provider then associates the UPC number with a barcode or other indicator. The provider the (again preferably through the “app”) sends an appropriate indicator bar code or the like, understood to be some product identifier recognizable by the retailer) preferably automatically recognizable by the retailer at POS, to the consumer. This barcode or indicator will be associated by the provider with the requested pay/load of the identified consumer account at a biller and will call for a payment of an appropriate price to the retailer. “Barcode” should be understood to be used herein in an exemplary fashion. Any indicator such as a barcode could be sent by the provider to the consumer, in particular through the supplied “app” to the consumer mobile device such as a mobile smart phone.

At the retailer stage, in Box VII the consumer “presents” the indicator or barcode provided to the consumer (preferably to the mobile device) by the provider to the retailer, again preferably using the “app.” Preferably, of course, the consumer “presents” the barcode to a retailer POS automatic reader, such as a barcode scanner from the consumer mobile device.

The register, in Box VIII, at the retailer preferably interprets the information, scanned or read from the presented barcode or the like and determines the price that the consumer needs to pay, and further likely determines receipt information that will be printed on a receipt for the consumer.

In Box IX the retailer collects the price from the consumer and then presents a receipt showing that the consumer has paid the price and purchased the identified “product.” The retailer's accounting system will keep a record of the sale of the UPC “products.”

At the pay/load and settlement stage in Box X the consumer sends to the provider receipt information. This receipt information might he a picture taken by the consumer's mobile smart phone, assisted by the consumer's app. Alternately or in addition, other forms of receipt information can be sent, including a copy of the barcode that indicates that it has been scanned by the retailer's scanner, or mobile phone history information, or coupon information.

In Box XI the provider pays and/or loads the previously identified consumer account at the biller by the previously identified amount. The provider will have agreed to pay and load the account in a reasonably timely fashion. The provider, however, may have leeway to delay paying the biller until the provider receives information from the retailer indicating that the consumer has in fact paid the price for the product. As above, the provider may determine from a copy of the bill to be paid how long the provider can delay before paying money into the consumer account. [Also, for inventory and marketing purposes retailers have been increasingly encouraged to provide to manufacturers periodic (such as hourly) summaries of sales of products at the retailer's establishment, including periodically during the day. The provider, thus, may wait, if possible, until receipt of such a summary report from the retailer, before paying the amount. Such further protects the provider against consumer fraud.] As above, the provider may also request or receive, or receive through the app provided to the consumer, further identifying information in regard to a purported consumer purchase of the pay/load product. E.g. the provider may attempt to coordinate historic: geographic GPS and camera information from the consumer's mobile smart phone to confirm activity at a retailer, and/or inspect computer data on the receipt, and/or attempt to verify that the indicator was scanned. Before the provider pays or loads the consumer account the provider may also pursue various statistical risk analysis verification steps, to attempt to rule out consumer fraud. The provider also confirms to the consumer the payment and provides the consumer a receipt thereof.

In Box XII the provider settles with the retailer, as by invoicing and collecting agreed amounts from the receipt of the prices charged and received by the retailer for the sales of the “products” over an agreed period of time. Settlement is typically performed in an ACH transaction.

The following discusses the preferred alternate embodiment of FIGS. 2B and 3B, in particular where the embodiment of 2B and 3B differs from that of 2A and 3A. The format of FIGS. 2A and 3A is preserved with four stages and 13 boxes.

In the first Box of the first stage of the preferred alternate embodiment of FIGS. 2B and 3B, the bill-pay provider establishes a program with the retailer (and/or the retailer's gift card processor if relevant.) The provider's authority to control and use certain gift card numbers is established, probably in certain ranges or otherwise identifiable in a block of gift card numbers that can be used in the retailer's system. Boxes II, III, IV and V are essentially the same as in FIGS. 2A and 3A where the provider sets up the consumer as a customer and preferably supplies an app to the consumer for communicating with the provider and the retailer.

In Box V the provider secures a gift card number or gift card account number, that originated from the retailer or the retailer's gift card processor, and associates the number with a bar code or other indicator. A UPC might also be associated with the gift card. In Box VI the gift card number and possibly UPC number is sent by the barcode or indicator to the consumer.

At the retailer's stage, in Box VII the consumer presents an indicator of the gift card number, such as by barcode, to the retailer point of sale. Preferably the indicator is scannable. In Box VIII the register at the point of sale of the retailer interprets the scanned indicator into a gift card number and price and receipt information. In Box IX the retailer collects the price and prints the receipt of the payment for the amount and informs the gift card processor, either in-house or outsourced, of the gift card number and the amount in order for the amount to be loaded into the account. It should be noted that the consumer is not informed that the consumer has put money into a gift card account. This account is not to be used for merchandise like other gift card accounts. The account is likely technically owned by the payment facilitator. The payment facilitator will dictate debiting the account.

In Box X the consumer sends the payment facilitator notification of the cash transaction and possibly receipt information. Importantly, if possible, the payment facilitator checks with the gift card processor to see if the gift card number supplied to the consumer is indeed loaded with the amount. Box XI is the same as in the embodiment of FIG. 3A, in that the facilitator pays or loads the payee and confirms with the consumer.

In Box XII the facilitator settles with the retailer possibly in a manner that is similar to settlement with other goods supplied. E.g. periodically, such as daily, the facilitator sends invoices for the number of amounts on its gift cards that have been reported to the provider or funded, or paid for by consumers. The retailer can do an ACH transfer to the facilitator's bank account and debit the gift cards to reflect a refund. An intermediate step may take place where the amount on the gift card is debited on the gift card account and credited to a purchase of a UPC product at the retailer. The retailer then pays the facilitator what amounts to an invoice for the sale of the UPC product, rather than a refund.

Note: FIG. 4 pages 1-5, found in both provisional applications incorporated by reference herein, contains background information on bar codes. FIG. 5 pages 1 through 12 of the two above provisional applications incorporated by reference offer representative samples of standard retailer receipts.

The foregoing description of preferred embodiments of the invention is presented for purposes of illustration and description, and is not intended to be exhaustive or to limit the invention to the precise form or embodiment disclosed. The description was selected to best explain the principles of the invention and their practical application to enable others skilled in the art to best utilize the invention in various embodiments. Various modifications as are best suited to the particular use are contemplated. It is intended that the scope of the invention is not to be limited by the specification, but to be defined by the claims set forth below. Since the foregoing disclosure and description of the invention are illustrative and explanatory thereof, various changes in the size, shape, and materials, as well as in the details of the illustrated device may be made without departing from the spirit of the invention. The invention is claimed using terminology that depends upon a historic presumption that recitation of a single element covers one or more, and recitation of two elements covers two or more, and the like. Also the drawings and illustration herein have not necessarily been produced to scale.

What is claimed is:

1. An improved method of immediate bill-pay or account loading wherein a payment facilitator (1) receives bill-pay or account loading information; (2) pays a consumer bill or loads a consumer account; and (3) settles directly or indirectly with a retailer who has received a cash payment from the consumer, the improved method comprising:
the payment facilitator
electronically sending to the consumer a presentable indicator related to the bill-pay or account loading information; and
subsequently verifying a cash payment from the consumer to the retailer associated with a presentation of the indicator to the retailer wherein the verifying includes receiving, directly or indirectly, information originating with the retailer in regard to the payment.

2. An improved method of immediate bill-pay or account loading wherein a payment facilitator (1) receives bill-pay or account loading information; (2) pays a consumer bill or loads a consumer account; and (3) settles directly or indirectly with a retailer who has received a cash payment from the consumer; the improved method comprising:
the payment facilitator
electronically sending to the consumer a presentable indicator related to the bill-pay or account loading information; and
subsequently verifying a cash payment from the consumer to the retailer associated with a presentation of the indicator to the retailer wherein the verifying includes accessing, directly or indirectly, in substantially real-time a retailer's, or retailer's agent's, database associating an indication of funds received, directly or indirectly, with the indicator.

3. An improved method of immediate bill-pay or account loading wherein a payment facilitator (1) receives bill-pay or account-loading information; (2) pays a consumer bill or loads a consumer account and (3) settles directly or indirectly with a retailer who has received a cash payment from the consumer, the improved method comprising:
the payment facilitator
electronically sending to a consumer mobile device a presentable indicator relating to the bill-pay or account-loading information, the presentable indicator suitable for presentation by display from the mobile device to a retailer point of sale device; and
subsequently verifying, directly or indirectly, a cash payment from the consumer to the retailer associated with a presentation of the indicator to the retailer.

4. The method of claims 1, 2 or 3 wherein the presentable indicator includes a bar code.

5. The method of claims 1 or 3 wherein the verifying information originating with the retailer includes a picture of a receipt from the cash payment transaction associated with the presentation of the indicator.

6. The method of claim 2 including the retailer's or retailer's agent's database comprising a gift card database.

7. The method of claim 6 wherein the accessing the retailer's or retailer's agent's database includes accessing a gift card database at a retailer's transaction processor.

8. The method of claim 2 that includes the payment facilitator settling with the retailer by applying funds placed in a gift card account to a purchase of a UPC related to a payment facilitator's product.

9. The method of claims 1, 2 or 3 including the payment facilitator supplying a software app to the consumer device to facilitate and/or authenticate communication with the provider.

10. The method of claim 9 wherein the supplying of the software app to the consumer includes a software app capable of presenting a barcode indicator to a retailer point of sale for scanning.

11. The method of claims 1, 2 or 3 that includes verifying the cash payment prior to paying the consumer bill.

12. A method of providing a bill-pay/account-loading product at retailers by a payment facilitator, comprising:
receiving consumer information regarding a consumer account at a third party and regarding an amount to be paid or loaded into the account;
providing a consumer with an automated POS-communicable indicator related to the amount and the account;
receiving, directly or indirectly, retailer receipt information indicating a cash payment to the retailer related to the POS-communicable indicator; and
paying into the consumer account an amount at least related to the amount to be paid and the cash payment.

13. The method of claim 12 wherein the receiving consumer information includes receiving information from the consumer and includes receiving information regarding the retailer.

14. The method of claim 12 wherein the receiving consumer information includes receiving through a software application (app) from a consumer mobile communication device.

15. The method of claim 12 wherein the providing an indicator includes supplying the indicator through a software application (app) to a consumer mobile communication device.

16. The method of claim 12 wherein the providing an indicator includes providing a barcode.

17. The method of claim 12 wherein the receiving retailer receipt information includes receiving through a software application (app) from a consumer mobile communication device.

18. The method of claim 12 wherein the retailer receipt information includes information regarding the funding of a retailer gift card account or a purchase of an indicated UPC product.

19. The method of claim 12 including enrolling a consumer into a bill-pay/account-loading program with the payment facilitator.

20. The method of claim 12 including supplying the retailer with a variable amount UPC or a plurality of UPCs associated with a plurality of values or price points related to a bill-pay/account loading product.

21. The method of claim 12 wherein the providing an indicator includes an indicator associated with a UPC or a retailer gift card account.

22. The method of claim 12 including confirming to the consumer the paying of the amount into the consumer account.

23. The method of claim 12 including periodically receiving, directly or indirectly from the retailer, reports on presented indicators and cash payments received.

24. The method of claim 12 including periodically receiving, from the retailer, remittance related to the cash payments to the retailer as indicated on retailer receipts and as related to the POS-communicated indicators.

25. The method of claim 12 including securing consumer agreement to pay a fee related to the payment of the amount into the consumer account.

26. The method of claim 12 including at least one additional verifying step for verifying the retailer receipt information against consumer fraud.

27. The method of claim 26 wherein the at least one additional verifying step includes periodically receiving retailer reports regarding payments received related to POS-communicated indicators and wherein the paying of the amount into the consumer account is delayed until subsequent to receiving a retailer report regarding a payment received related to a POS-communicated indicator.

28. The method of claim 26 wherein the at least one additional verifying step includes requesting the consumer to communicate a copy of a bill related to the consumer account and the amount.

29. The method of claim 26 wherein the at least one additional verifying step includes performing a risk analysis based upon at least two of: information regarding retailer receipt data; consumer history data; transaction history data; and consumer mobile communication device history data.

30. The method of claim 26 wherein the at least one additional verifying step includes securing data from a mobile communication device of the consumer, the data including at least one of: GPS history data; gyroscope history data; camera history data, and microphone history data.

31. The method of claims 14 or 15 that includes providing the app to the consumer by the payment facilitator.

32. A method of paying/loading consumer accounts at third parties, comprising:
receiving, by a payment facilitator, from a consumer, information regarding a consumer cash payment to a retailer, the payment associated with (1) a uniform product code (UPC) supplied by the payment facilitator to the consumer and to the retailer or (2) with a retailer gift card account number supplied by the retailer or retailer's agent to the facilitator; and
tendering a payment by the facilitator to a consumer account at a third party, the tendered payment related to the consumer cash payment information.

33. The method of claim 32 wherein the receiving is from a computer application (app) supplied directly or indirectly by the facilitator to a consumer device.

34. The method of claim 33 including supplying to the app at least a POS-communicable UPC or retailer gift card account number.

35. The method of claim 34 including supplying to the retailer a plurality of UPC's associated with the facilitator together with a plurality of related price points, or a variable amount UPC.

36. The method of claim 32 wherein receiving information regarding a consumer cash payment to a retailer includes receiving information in regard to a receipt issued by the retailer to the consumer or receiving information in regard to funds in a retailer gift card account.

37. The method of claim 36 wherein receiving information includes information related to a consumer device and related to the time of a consumer cash payment to the retailer.

38. The method of claim 32 wherein receiving information regarding a consumer payment to a retailer includes receiving information in regard to a coupon issued by the facilitator to the consumer.

39. A method of bill-pay or account-loading at third parties by a payment facilitator on behalf of a consumer, comprising:
by a consumer,
enrolling with the payment facilitator;
contacting the facilitator regarding a bill-pay/account-loading transaction;
receiving an indicator on an electronic device by the consumer from the facilitator associated with the bill-pay/account loading transaction;
presenting the indicator or a function of the indicator to a retailer at a retailer point of sale (POS;)
performing a cash payment transaction at the retailer POS;
receiving a record regarding the cash payment transaction with respect to the indicator;
communicating at least a portion of the record to the facilitator; and
instructing the facilitator to perform a bill-pay/account-loading transaction with respect to a consumer account at a third party.

40. The method of claim 39 that includes the consumer contacting the facilitator on an electronic device and regarding a retailer.

41. The method of claim 39 including performing a cash payment transaction at a retailer point of sale with a cash amount specified by the retailer.

42. The method of claim 39 that includes instructing the facilitator to perform the bill-pay or account loading transaction with respect to a consumer account at a third party for the cash amount or a function of the cash amount and making available information regarding the record associated with the cash payment transaction to the facilitator.

43. The method of claim 39 wherein the indicator relates to a UPC or a gift card account number.

44. Mobile device communication software for facilitating bill payments or loading of accounts, comprising:
consumer mobile communication device software structured to communicate to a payment facilitator:
(1) information regarding a consumer mobile communication device GPS history;
(2) information regarding a receipt generated at a retailer POS reflecting a cash payment related to a UPC or gift card account number; and
(3) information regarding an account at a third party and an amount;
and further structured to facilitate communicating from a payment facilitator a scannable UPC and/or gift card account number;
and further structured to facilitate presenting the UPC and/or gift card account number to a retailer point of sale.

45. The software of claim 44 wherein the information regarding the consumer mobile communication device includes device gyroscopic information history.

46. A method of bill-pay/account-loading by a payment facilitator for an enrolled consumer based upon a cash transaction at a retailer, the method comprising:
the consumer receiving, directly or indirectly, an indicator from the payment facilitator;
the consumer electronically presenting the indicator, or a function of the indicator, to a retailer at a point of sale wherein the indicator relates to an amount in cash paid or to be paid at the point of sale and wherein the amount is related to a pay/load instruction made or to be made to the payment facilitator relating to a consumer account at a third party; and
either the consumer electronically sending a function of a receipt of a cash payment transaction at the retailer point of sale to the payment facilitator or the consumer electronically funding a retailer gift card account.

47. The method of claim 46 wherein the consumer receives the indicator on a mobile electronic device, and wherein the consumer presents the indicator to the retailer at the point of sale using the mobile electronic device.
